(19) United States
(12) Patent Application Publication
(10) Pub. No.: US 2004/0233434 A1
(43) Pub. Date: Nov. 25, 2004

(54) Accuracy calibration of birefringence measurement systems

(76) Inventor: Baoliang Wang, Beaverton, OR (US)

Correspondence Address: IPSOLON LLP, 805 SW BROADWAY, #2740, PORTLAND, OR, 97205, US

(21) Appl. No.: 10/491,860

(22) PCT Filed: Oct. 16, 2002
(86) PCT No.: PCT/US02/33585

Related U.S. Application Data
(60) Provisional application No. 60/329,680, filed on Oct. 16, 2001.

(51) Int. Cl. G01J 4/00

(52) U.S. Cl. 356/365

(57) ABSTRACT

Provided are systems and methods using a Soleil-Babinet compensator (101) as a standard for calibrating birefringence measurement systems. Highly precise and repeatable calibration is accomplished by the method described here because, among other things, the inventive method accounts for variations of retardance across the surface of the Soleil-Babinet compensator (101). The calibration technique described here may be employed in birefringence measurement systems that have a variety of optical setups for measuring a range of retardation levels and at various frequencies of light sources.

This application claims the benefit of the filing date of U.S. Provisional Patent Application No. 60/329,680, hereby incorporated by reference.

### TECHNICAL FIELD

This application generally relates to systems that precisely measure birefringence properties of optical elements, and particularly to the use of a Soleil-Babinet compensator for calibrating such systems.

### BACKGROUND

Many important optical materials exhibit birefringence. Birefringence means that different linear polarizations of light travel at different speeds through the material. These different polarizations are most often considered as two components of the polarized light, one being orthogonal to the other.

Birefringence is an intrinsic property of many optical materials, and may be induced by external forces. Retardation or retardance represents the integrated effect of birefringence acting along the path of a light beam traversing the sample. If the incident light beam is linearly polarized, two orthogonal components of the polarized light will exit the sample with a phase difference, called the retardance. The fundamental unit of retardance is length, such as nanometers (nm). It is frequently convenient, however, to express retardance in units of phase angle (waves, radians, or degrees), which is proportional to the retardance (nm) divided by the wavelength of the light (nm). An “average” birefringence for a sample is sometimes computed by dividing the measured retardation magnitude by the thickness of the sample.

Oftentimes, the term “birefringence” is interchangeably used with and carries the same meaning as the term “retardance.” Thus, unless stated otherwise, those terms are also interchangeably used below.

The two orthogonal polarization components described above are parallel to two orthogonal axes, which are determined by the sample and are respectively called the “fast axis” and the “slow axis.” The fast axis is the axis of the material that aligns with the faster moving component of the polarized light through the sample. Therefore, a complete description of the retardance of a sample along a given optical path requires specifying both the magnitude of the retardance and its relative angular orientation of the fast (or slow) axis of the sample.

The need for precise measurement of birefringence properties has become increasingly important in a number of technical applications. For instance, it is important to specify linear birefringence (hence, the attendant induced retardance) in optical elements that are used in high-precision instruments employed in semiconductor and other industries.

Moreover, the optical lithography industry is transitioning to the use of very short exposure wavelengths for the purpose of further reducing line weights (conductors, etc.) in integrated circuits, thereby to enhance performance of those circuits. In this regard, the next generation of optical lithography tools will use laser light having a wavelength of about 157 nanometers, which wavelength is often referred to as deep ultraviolet or DUV.

It is important to precisely determine the retardance properties of optical elements or components that are used in systems, such as lithography tools, that employ DUV. Such a component may be, for example, a calcium fluoride (CaF₂) lens of a scanner or stepper. Since the retardance of such a component is a characteristic of both the component material as well as the wavelength of light penetrating the material, a system for measuring retardance properties must operate with a DUV light source and associated components for detecting and processing the associated light signals.

The magnitude of the measured retardance of an optical element is a function of the thickness of the element, the thickness being measured in the direction that the light propagates through the sample. For example, a CaF, optical element will have an intrinsic birefringence of about 11 nm for every centimeter (cm) of thickness. Consequently, for example, a 10 cm-thick CaF₂ element will have a relatively high birefringence level of about 110 nanometers, which is about three-quarters of a 157 nm DUV wavelength.

Systems for measuring birefringence of a sample have been developed and use an optical setup (arrangement of light source, optical elements, detectors etc.) that includes polarization modulators. An example of such a system is described in U.S. Pat. No. 6,473,179 and includes a photoelastic modulator (PEM) for modulating polarized light that is then directed through a sample. The beam propagating from the sample is separated into two parts. These separate beam parts are then analyzed at different polarization directions, detected, and processed as distinct channels. The detection mechanisms associated with each channel detect the light intensity corresponding to each of the two parts of the beam. This information is employed in an algorithm for calculating a precise, unambiguous measure of the retardance induced by the sample as well as the angular orientation of birefringence relative to the fast axis of the sample.

Birefringence measurement systems such as the exemplary one just mentioned may be constructed to be self-calibrating. However, such a system requires extremely accurate settings to report accurate results. It is therefore useful to have a reliable way of calibrating such systems by using an external optical element.

### SUMMARY OF THE INVENTION

The present invention is directed to the use of a Soleil-Babinet compensator as an external optical element for calibrating birefringence measurement systems. A Soleil-Babinet compensator is an instrument that includes movable optical elements for inducing a known, selected retardance to a light beam that propagates through it. Highly precise and repeatable calibration is accomplished by the method described here because, among other things, the inventive method accounts for variations of retardance across the surface of the Soleil-Babinet compensator.

The calibration technique described here may be employed in birefringence measurement systems that have a variety of optical setups for measuring a range of retardation levels and at various frequencies of light sources. For example, the present invention is adaptable to systems that precisely measure birefringence properties of optical elements such as those elements that are used in DUV applications as mentioned above.

The approach to calibration in accordance with the present invention can be selectively varied somewhat in complexity to allow for the use of versions of the method to match the desired accuracy of the system with which the calibration method is employed.

Other advantages and features of the present invention will become clear upon study of the following portion of this specification and drawings.

### BRIEF DESCRIPTION OF DRAWINGS

FIG. 1 is a diagram of a birefringence measurement system to which one embodiment of the present invention may be adapted.

FIG. 2 is a block diagram of the signal processing components of the system of FIG. 1.

FIG. 3 is a perspective view of detection and beam-splitting components of the system of FIG. 1.

FIG. 4 is a cross-sectional view of one of the detector assemblies of the system of FIG. 1.

FIG. 5 is a perspective view of the primary components of a photoelastic modulator that is incorporated in the system of FIG. 1.

FIG. 6 is a drawing depicting a graphical display provided by the system of FIG. 1.

FIG. 7 is a diagram of another birefringence measurement system to which one embodiment of the present invention may be adapted.

FIG. 8 is a block diagram of the signal processing components of the system depicted in FIG. 7.

FIG. 9 is a diagram of another birefringence measurement system to which one embodiment of the present invention may be adapted.

FIG. 10 is a block diagram of the signal processing components of the system depicted in FIG. 9.

### BEST MODES FOR CARRYING OUT THE INVENTION

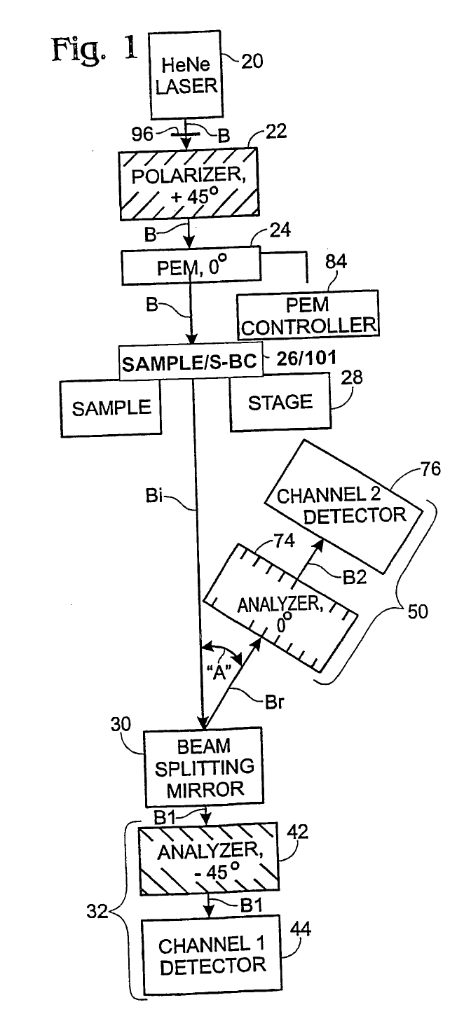

The diagram of FIG. 1 depicts the primary optical components of a system that can be calibrated in accordance with the present invention. The components include a HeNe laser as a light source 20 that has a wavelength of 632.8 nanometers (nm). The beam “B” emanates from the source along an optical path and has a cross sectional area or “spot size” of approximately 1 millimeter (mm).

The source light beam “B” is directed to be incident on a polarizer 22 that is oriented with its polarization direction at +45° relative to a baseline axis. A high-extinction polarizer, such as a Glan-Thompson calcite polarizer, is preferred. It is also preferred that the polarizer 22 be secured in a precision, graduated rotator.

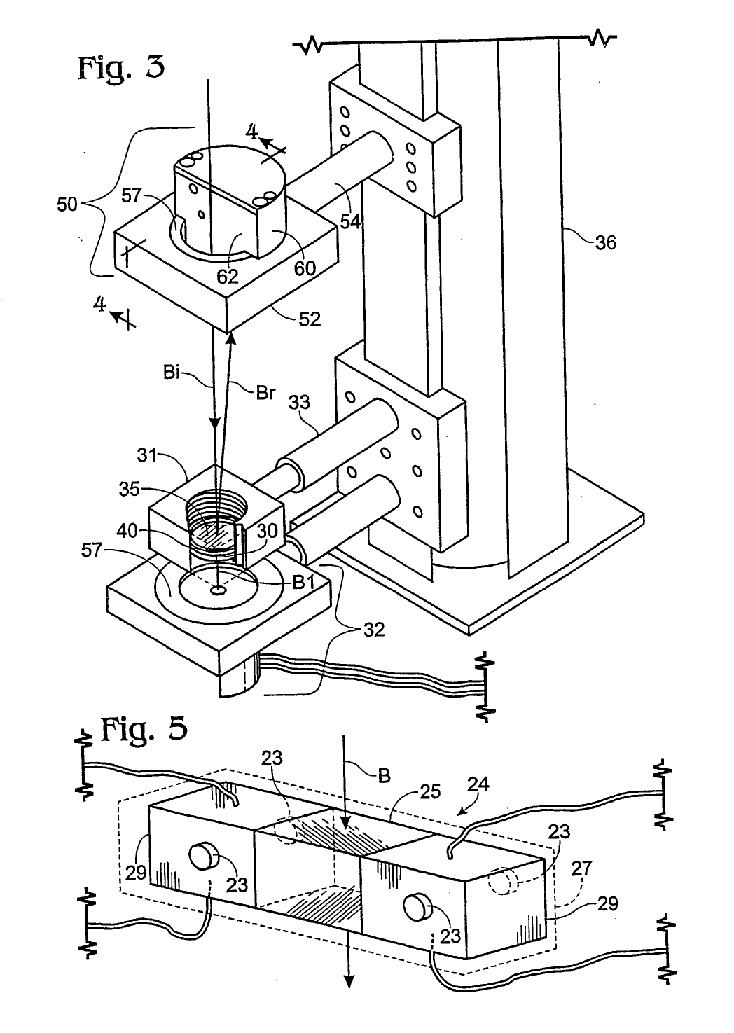

The polarized light from the polarizer 22 is incident on the optical element 25 of a photoelastic modulator 24 (FIGS. 1 and 5). In a preferred embodiment, the photoelastic modulator (hereafter referred to as a “PEM”) is one manufactured by Hinds Instruments, Inc., of Hillsboro, Oreg., as a low birefringence version of Model PEM-90 I/FS50. It is noteworthy here that although a PEM is preferred, one could substitute other mechanisms for modulating the polarization of the source light.

The PEM has its birefringent axis oriented at 0° and is controlled by a controller 84 that imparts an oscillating birefringence to the optical element 25, preferably at a nominal frequency of 50 kHz. In this regard, the controller 84 drives two quartz transducers 29 between which the optical element 25 is bonded with an adhesive.

The oscillating birefringence of the PEM introduces a time-varying phase difference between the orthogonal components of the polarized light that propagates through the PEM. At any instant in time, the phase difference is the retardation introduced by the PEM. The retardation is measurable in units of length, such as nanometers. The PEM is adjustable to allow one to vary the amplitude of the retardation introduced by the PEM. In the case at hand, the retardation amplitude is selected to be 0.383 waves (242.4 nm).

The beam of light propagating from the PEM is directed through the transparent sample 26. The sample is supported in the path of the beam by a sample stage 28 that is controllable for moving the sample in a translational sense along orthogonal (X and Y) axes. The stage may be any one of a number of conventional designs such as manufactured by THK Co. Ltd., of Tokyo, Japan as model KR2602 A-250. As will become clear, the motion controllers of the sample stage 28 are driven to enable scanning the sample 26 with the beam to arrive at a plurality of retardance and orientation measurements across the area of the sample.

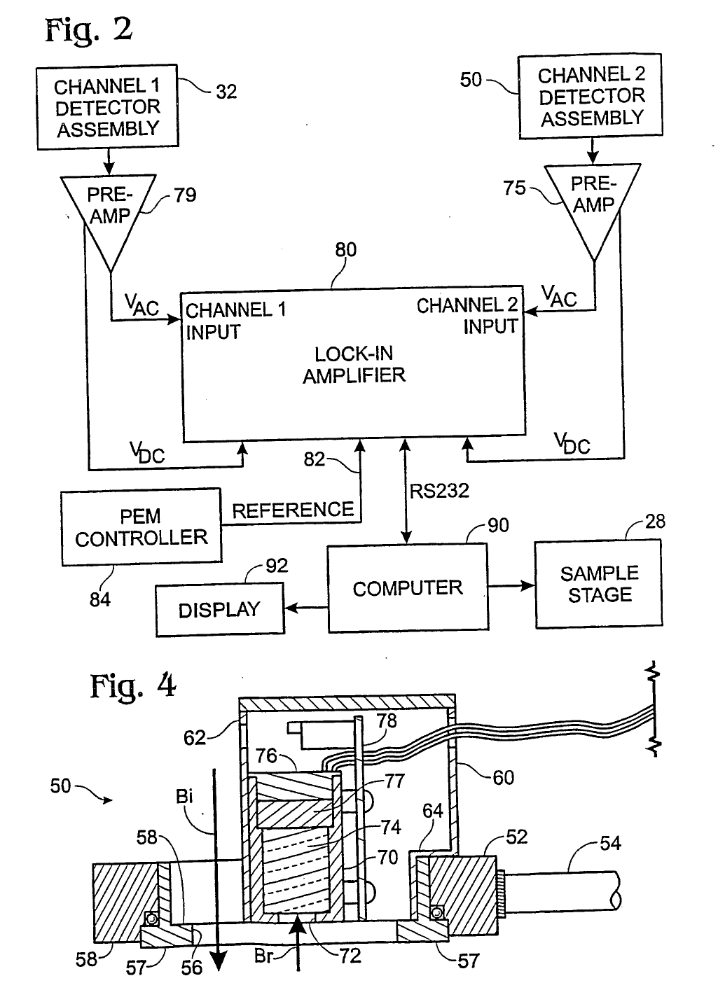

The sample 26 will induce retardance into the beam that passes through it. The system depicted FIGS. 1 and 2 determines this retardance value, as explained more below. The system is especially adapted to determine low levels of retardance. Low retardance levels are determined with a sensitivity of less than ±0.01 nm.

In order to obtain an unambiguous measure of the sample-induced retardance, the beam “Bi” that passes out of the sample is separated into two parts having different polarization directions and thereby defining two channels of information for subsequent processing.

A beam-splitting mirror 30 for separating the beam “Bi” is located in the path of that beam (hereafter referred to as the incidence path). Part “B1” of the beam “Bi” passes completely through the beam-splitting mirror 30 and enters a detector assembly 32 for detection.

FIG. 3 depicts a mechanism for supporting the beam-splitting mirror 30. In particular, the mirror 30 is seated in the central aperture of a housing 31 that is rigidly supported by an arm 33 to a stationary vertical post 36. The post 36 is employed for supporting all of the optical components of the system so that the paths of the light are generally vertical.

The diameter of the mirror 30 is slightly less than the diameter of the housing aperture. The aperture is threaded except for an annular shoulder that projects into the lowermost end of the aperture to support the periphery of the flat, round mirror 30. A retainer ring 40 is threaded into the aperture to keep the mirror in place in the housing 31 against the shoulder.

The mirror 30 is selected and mounted so that substantially no stress-induced birefringence is introduced into the mirror. In this regard, the mirror is preferably made of Schott Glass type SF-57 glass. This glass has an extremely low (near zero) stress-optic coefficient. The retainer ring 40 is carefully placed to secure the mirror without stressing the glass. Alternatively, flexible adhesive may be employed to fasten the mirror. No setscrews or other stress-inducing mechanisms are employed in mounting the mirror. Other mechanisms (such as a flipper mirror arrangement) for separating the beam “Bi” into two parts can be used.

The part of the beam “B1” that passes through the mirror 30 enters the detector assembly 32 (FIG. 1), which includes a compact, Glan-Taylor type analyzer 42 that is arranged such that its polarization direction is at −45° from the baseline axis. From the analyzer 42, the beam “B1” enters a detector 44, the particulars of which are described more below.

The reflective surface 35 of the beam-splitting mirror 30 (FIG. 3) faces upwardly, toward the sample 26. The mirror is mounted so that the incidence path (that is, the optical path of the beam “Bi” propagating from the sample 26) is nearly normal to the reflective surface 35. This orientation substantially eliminates retardance that would otherwise be introduced by an optical component that is called on to redirect the path of the beam by more than a few degrees.

FIG. 1 shows as “A” the angle made between the beam “Bi” traveling along the incidence path and the beam part “Br” that is reflected from the mirror 30. Angle “A” is shown greatly enlarged for illustrative purposes. This angle is generally about 5°.

The reflected part of the light beam “Br” is incident upon another detector assembly 50. That assembly 50 is mounted to the post 36 (FIG. 3) and configured in a way that permits the assembly to be adjacent to the incident beam “Bi” and located to receive the reflected beam “Br.” More particularly, the assembly 50 includes a base plate 52 that is held to the post 36 by an arm 54. As seen best in FIG. 4, the base plate includes an inner ring 57 that is rotatably mounted to the base plate and has a large central aperture 56 that is countersunk to define in the bottom of the plate 52 an annular shoulder 58.

The detector components are compactly integrated and contained in a housing 60 that has a flat front side 62. The remainder of the side of the housing is curved to conform to the curvature of the central aperture 56 of the base plate 52. Moreover, this portion of the housing 60 includes a stepped part 64 that permits the curved side of the housing to fit against the base plate 52 and be immovably fastened thereto.

A sub-housing 70 is fastened inside of the detector components housing 60 against the flat side 62. The sub-housing 70 is a generally cylindrical member having an aperture 72 formed in the bottom. Just above the aperture 72 resides a compact, Glan-Taylor type analyzer 74 that is arranged so that its polarization direction is 0°, parallel with that of the PEM 24.

Stacked above the analyzer 74 is a narrow-band interference filter 77 that permits passage of the polarized laser light but blocks unwanted room light from reaching a detector 76. The detector is preferably a photodiode that is stacked above the filter. The photodiode detector 76 is the preferred detection mechanism and produces as output a current signal representative of the time varying intensity of the received laser light. With respect to this assembly 50, the laser light is that of the beam “B2,” which is the reflected part “Br” of the beam that propagated through the sample 26.

The photodiode output is delivered to a preamplifier carried on an associated printed circuit board 78 that is mounted in the housing 60. The preamplifier 75 (FIG. 2) provides output to a phase sensitive device (preferably a lock-in amplifier 80) in the form of a low-impedance intensity signal VAC, and a DC intensity signal VDC, which represents the time average of the detector signal.

The other detector assembly 32 (FIG. 3) to which is directed the non-reflected part “B1” of the beam “Bi” is, except in two respects, the same construction as the just described assembly 50. As shown in FIG. 3, the detector assembly 32 is mounted to the post 36 in an orientation that is generally inverted relative to that of the other detector assembly 50. Moreover, the analyzer 42 of that assembly 32 is arranged so that its polarization direction is oblique to the polarization direction of the analyzer 74 in the other detector assembly 50. Specifically, the analyzer 42 is positioned with its polarization direction at −45°. The preferred analyzer position is established by rotating the detector assembly via the inner ring 57 discussed above.

The photodiode of detector assembly 32 produces as output a current signal representative of the time varying intensity of the received laser light. With respect to this assembly 32, the laser light is that of the beam “B1,” which is the non-reflected part of the beam “Bi” that propagated through the sample 26.

The photodiode output of the detector assembly 32 is delivered to a preamplifier 79, which provides its output to the lock-in amplifier 80 (FIG. 2) in the form of a low-impedance intensity signal VAC, and a DC intensity signal VDC, which represents the time average of the detector signal.

In summary, the lock-in amplifier 80 is provided with two channels of input: channel 1 corresponding to the output of detector assembly 32, and channel 2 corresponding to the output of detector assembly 50. The intensity information received by the lock-in amplifier on channel 1—because of the arrangement of the—45° analyzer 42—relates to the 0° or 90° component of the retardance induced by the sample 26. The intensity information received on channel 2 of the lock-in amplifier 80—as a result of the arrangement of the 0° analyzer 74—relates to the 45° or −45° component of the retardance induced by the sample. As explained below, this information is combined in an algorithm that yields an unambiguous determination of the magnitude of the overall retardance induced in the sample (or a location on the sample) as well as the orientation of the fast axis of the sample (or a location on the sample).

The lock-in amplifier 80 may be one such as manufactured by EG&G Inc., of Wellesley, Mass., as model number 7265. The lock-in amplifier takes as its reference signal 82 the oscillation frequency applied by the PEM controller 84 to the transducers 29 that drive the optical element 25 of the PEM 24. The lock-in amplifier 80 communicates with a digital computer 90 via an RS232 serial interface.

For a particular retardance measurement, such as one taken during the scanning of several locations on a sample, the computer 90 obtains the values of channel 1. The computer next obtains the values of channel 2. The intensity signals on the detectors in channels 1 and 2 are derived as follows:

$$\begin{matrix}{I}_{clt1} = 1 + cos ( 4 ρ ) {sin}^{2} [ \frac{δ}{2} ] cos Δ - {cos}^{2} [ \frac{δ}{2} ] cos Δ + cos ( 2 ρ ) sin δsinΔ \\ {I}_{clt2} = 1 + sin ( 4 ρ ) {sin}^{2} [ \frac{δ}{2} ] cos Δ + sin ( 2 ρ ) sin δsinΔ\end{matrix} \qquad eqn . ( 1 )$$

where Δ is the PEM's time varying phase retardation; δ is the magnitude of the sample's retardance; and ρ is the azimuth of the fast axis of the sample's retardance. The Mueller matrix for a linearly birefringent sample (δ, ρ) used in the derivation has the following form:

$$[ \begin{matrix}1 & 0 & 0 & 0 \\ 0 & cos ( 4 \cdot ρ ) \cdot {sin ( \frac{δ}{2} )}^{2} + {cos ( \frac{δ}{2} )}^{2} & sin ( 4 \cdot ρ ) \cdot {sin ( \frac{δ}{2} )}^{2} & - sin ( 2 \cdot ρ ) \cdot sin ( δ ) \\ 0 & sin ( 4 \cdot ρ ) \cdot {sin ( \frac{δ}{2} )}^{2} & - ( cos ( 4 \cdot ρ ) \cdot {sin ( \frac{δ}{2} )}^{2} ) + {cos ( \frac{δ}{2} )}^{2} & cos ( 2 \cdot ρ ) \cdot sin ( δ ) \\ 0 & sin ( 2 \cdot ρ ) \cdot sin ( δ ) & - ( cos ( 2 \cdot ρ ) \cdot sin ( δ ) ) & cos ( δ )\end{matrix} ]$$

In equations (1), sin Δ (Δ=Δ0 sin ωt, where ω is the PEM's modulating frequency; Δ0 is the maximum peak retardance of the PEM) can be expanded with the Bessel functions of the first kind:

$$sin Δ = sin ( {Δ}_{0} sin ( ω t ) ) = {\sum }_{2 k = 1}^{} 2 {J}_{2 k + 1} ( {Δ}_{0} ) sin ( 2 k + 1 ) ω t ) \qquad eqn . ( 2 )$$

where k is either “0” or a positive integer; and J₂ₖ₊₁ is the (2k+1)th order of the Bessel function. Similarly, cos Δ can be expanded with the even harmonics of the Bessel functions:

$$cos Δ = cos ( {Δ}_{0} sin ( ω t ) ) = {J}_{0} ( {Δ}_{0} ) + {\sum }_{2 k}^{} 2 {J}_{2 k} ( {Δ}_{0} ) cos ( 2 k ) ω t ) \qquad eqn . ( 3 )$$

where J₀ is the 0^{th} order of the Bessel function, and J₂ₖ is the (2k)th order of the Bessel function.

As seen from eqns. 1-3, it is preferable to determine the magnitude and angular orientation of retardance using the signal at the PEM's first harmonic. The useful signal for measuring linear birefringence at the PEM's 2nd harmonic is modified by sin 2(δ/2), a value that is much smaller than sin δ. The 1F electronic signal on the detectors can be expressed in equation (4):

I_{ch 1,1F}=sin δ cos(2ρ)2J₁(Δ₀)sin(ωt)

I_{ch 2,1F}=sin δ sin(2ρ)2J₁(Δ₀)sin(ωt) eqn. (4)

As noted, the 1F signal is determined using the lock-in amplifier 80 that is referenced at the PEM's first harmonic. The lock-in amplifier will exclude the contributions from all harmonics other than 1F. The output from the lock-in amplifier 80 for the two channels is:

I_{ch 1}(1F)=sin δ cos(2ρ)2J₁(Δ₀)\sqrt{2}

I_{ch 2}(1F)=sin δ sin(2ρ)2J₁(Δ₀)\sqrt{2} eqn. (5)

The value √2 results from the fact that the lock-in amplifier measures the r.m.s. of the signal, instead of the amplitude.

All terms appearing at a frequency other than the PEM's first harmonic are neglected in obtaining equations (5). The validity of equations (5) for obtaining the 1F V_{AC} signal is further ensured from the approximation that sin²(δ/2)≈0 when δ is small. This applies for low-level retardance of, for example, less than 20 nm.

In order to eliminate the effect for intensity fluctuation of the light source, or variations in transmission due to absorption, reflection losses, or scattering, the ratio of the 1F V_{AC} signal to the V_{DC} signal is used. (Alternatively, similar techniques can be employed, such as dynamically normalizing the DC signal to unity.) Exclusion of the cos Δ terms in equation (1) can severely affect the V_{DC} signal in channel 1 even though it has a minimal effect on the determination of the 1F V_{AC} signal using a high quality lock-in amplifier. The term cos²(δ/2)cos Δ in equation (1) is approximately equal to cos Δ for small δ. As seen from equation (3), cos Δ depends on J₀(Δ₀), which is a “DC” term. Consequently, this DC term should be corrected as in equations (6):

$$\begin{matrix}\frac{{I}_{clt1} ( 1 F )}{{I}_{dc}} \cdot \frac{1 - {J}_{0} ( {Δ}_{0} )}{2 {J}_{1} ( {Δ}_{0} )} \cdot \frac{1}{\sqrt{2}} = {R}_{ch1} = sin δ cos ( 2 ρ ) \\ \frac{{I}_{ch2} ( 1 F )}{{I}_{dc}} \cdot \frac{1}{2 {J}_{1} ( {Δ}_{0} )} \cdot \frac{1}{\sqrt{2}} = {R}_{ch2} = sin δ sin ( 2 ρ )\end{matrix} \qquad eqn . ( 6 )$$

where R_{ch1} and R_{ch2} are experimentally determined quantities from the two channels.

To correct the “DC” term caused by the cos Δ term in channel 1, one properly sets the PEM retardation so that J₀(Δ₀)=0 (when Δ₀=2.405 radians, or 0.383 waves). At this PEM setting, the efficiency of the PEM for generating the 1F signal is about 90% of its maximum.

Finally, the magnitude and angular orientation of the linear birefringence is expressed in equations (7):

$$\begin{matrix}ρ = \frac{1}{2} {tan}^{- 1} [ \frac{{R}_{ch2}}{{R}_{ch1}} ] or ρ = \frac{1}{2} {ctg}^{- 1} [ \frac{{R}_{ch1}}{{R}_{ch2}} ] \\ δ = {sin}^{- 1} \sqrt{{( {R}_{ch1} )}^{2} + {( {R}_{ch2} )}^{2}}\end{matrix} \qquad eqn . ( 7 )$$

The retardation δ is represented in radians. It can be converted to degrees, number of waves and nanometers “nm” at the wavelength of measurement (e.g., 632.8 nm as used here). Thus, the above retardation is converted to nanometers “nm” by multiplying that amount by the wavelength (in nm) divided by 2π.

These equations (7) are compiled in a program running on the computer 90 and used to determine the magnitude and orientation of the retardance at any selected point on the sample.

The birefringence measurement system described here employs a PEM 24 (FIG. 5) that is specially configured to eliminate residual birefringence that may result from supporting the optical element 25 of the PEM in the housing 27 (shown in dashed lines of FIG. 5). The bar-shaped optical element is bonded at each end to a transducer 29. Each transducer 29 is mounted to the PEM housing 27, as by supports 23, so that the optical element is essentially suspended, thus free from any residual birefringence that may be attributable to directly mounting the oscillating optical element 25 to the PEM housing 27.

The results of equations 8 are corrected to account for any remaining residual birefringence in the system, which residual may be referred to as the system offset. In practice, residual birefringence in the optical element of the photoelastic modulator and in the beam-splitting mirror substrate can induce errors in the resulting measurements. Any such errors can be measured by first operating the system with no sample in place. A correction for the errors is made by subtracting the error values for each channel.

The system offset is obtained by making a measurement without a sample in place. The results from both channels 1 and 2 are the system offsets at 0° and 45° respectively:

$$\begin{matrix}{R}_{ch1}^{0} = \frac{{I}_{ch1}^{0} ( 1 F )}{2 {J}_{1} ( {Δ}_{0} ) {I}_{dc1}^{0}} = sin {δ}^{0} ( ρ = 0 ) \\ {R}_{ch2}^{0} = \frac{{I}_{ch2}^{0} ( 1 F )}{2 {J}_{1} ( {Δ}_{0} ) {I}_{dc2}^{0}} = sin {δ}^{0} ( ρ = \frac{π}{4} )\end{matrix} \qquad eqn . ( 8 )$$

where the superscript “0” indicates the absence of a sample. The equation bearing the term ρ=0 corresponds to channel 1 (the −45° analyzer 42). The equation bearing the term ρ=π/4 corresponds to channel 2 (the 0° analyzer 74). The system offsets are corrected for both channels when a sample is measured. The system offsets for channels 1 and 2 are constants (within the measurement error) at a fixed instrumental configuration. Barring any changes in the components of the system, or in ambient pressure or temperature, the system's offsets should remain the same.

In principle, this system is self-calibrating with ideal settings for all components in the system. It is, however, prudent to compare the system measurement of a sample with the measurement obtained using other methods as explained next.

In accordance with the present invention a conventional Soleil-Babinet compensator is used as an external optical element in one method for calibrating the accuracy of a birefringence measurement system such as the one just described with respect to FIGS. 1-5. During the calibration process, the Soleil-Babinet compensator 101 (FIG. 1) is substituted for the sample 26, as explained more below.

A suitable Soleil-Babinet compensator 101 may be one as manufactured by Special Optics, of Wharton, N.J. It is composed of three single-crystal quartz (or magnesium fluoride for use with the DUV birefringence measurement systems described below) optical elements: one fixed wedge, one translational wedge, and one rectangular prism. The two quartz (or magnesium fluoride) wedges have their principal optical axes parallel to each other while the quartz (or magnesium fluoride) prism has its principal optical axis perpendicular to that of the wedge assembly. The mechanical translation of one of the quartz (or magnesium fluoride) wedges is by a micrometer, thereby providing the selectable variation of retardation induced by the compensator. Such compensators are generically known as mechanically variable retarders.

The Soleil-Babinet compensator is mounted on a ball bearing indexing head which has a fixed outer circumference graduated 0°, 180°, +45°, +90°, +135°, −45°, −90° and −135°. The inner circumference carries the optical elements and is rotatable through 360° and has indicator marks at one-degree increments. A knurled locking screw in the outer circumference is used to fix the rotational position.

Precise and repeatable calibration is accomplished by the method described hereafter because, among other things, the method accounts for variations of retardance that may occur across the surface of the Soleil-Babinet compensator.

In accordance with one approach to the present invention, the birefringence measurement system accuracy calibration method begins by locating the Soleil-Babinet compensator 101 in the position normally assumed by the sample 26. The compensator 101 is then oriented at exactly 0° (“0°” is defined by the PEM's optical axis in the birefringence measurement system). This orientation is accomplished by minimizing the PEM's first harmonic signal at the channel 2 detector 76 while rotating the Soleil-Babinet compensator. As previously described, the 1F signal at channel 2 of the birefringence system is nulled when the sample is oriented at “0°”.

Preferably, a fairly large retardation level should be selected on the Soleil-Babinet compensator during this orientation or aligning step so that one obtains an angular accuracy of about 0.05 degrees. In this embodiment, for example, a retardation level of about 100 nm should be set at the Soleil-Babinet compensator. Put another way, at such a retardation level a change in the 1F signal at channel 2 of about 0.1 mV is easily observable, and corresponds to a less than 5 miliarc angle change of the Soleil-Babinet compensator. The maximum 1F signal when the Soleil-Babinet compensator is oriented at 45° is usually about 400 mV.

The modulation of the light beam is then halted, preferably by removing the PEM 24 from the path of the beam “B.” This approach eliminates concerns about any residual birefringence in the PEM affecting the accuracy of the calibration process. As an acceptable alternative, however, the PEM 24 may merely be turned off and remain in the path of the beam. This alternative is acceptable when, as here, the PEM has a residual birefringence of less than 0.2 nm. Also, depending on the configuration of the optical setup, this alternative may make it easier to maintain the position of the beam on a single location of the Soleil-Babinet compensator aperture surface, which is required for greatest accuracy.

The beam-splitting mirror 30 is removed from the optical path of the beam B. It will be appreciated that, as respects channel 1, the resulting setup thus places the Soleil-Babinet compensator 101 between the +45° polarizer 22 and the −45° analyzer 42, which comprise what is known in the art as “crossed polarizers.”

The Soleil-Babinet compensator itself 101 is then calibrated using the crossed polarizers. This is done by recording the DC signals at the channel 1 detector 44 while the micrometer of the Soleil-Babinet compensator 101 is moved (not the Soleil-Babinet compensator itself) to select several retardation levels in the vicinity of the compensator settings for both the zero retardation and full-wave (in this embodiment, 632.8 nm) retardation. The recorded DC signal information is processed to determine the minimum DC value in the vicinity of the zero and full-wave signals. The micrometer settings associated with these minimums are noted and used to interpolate the relationship between the micrometer settings and the retardation values induced (that is, to calibrate the Soleil-Babinet compensator).

After this calibration of the Soleil-Babinet compensator, the PEM 24 operation in the optical path is restored and the beam splitting mirror 30 is replaced in order to allow use of the birefringence measurement system for measuring retardation levels of the Soleil-Babinet compensator 101 for later comparison with the same-micrometer-setting values of retardation obtained via the cross polarizer approach just described.

It is noteworthy here that in the course of reconfiguring the optical setup to move between calibrating and measuring the retardation levels of the Soleil-Babinet compensator 101 (that is, in this embodiment, restoring the PEM 24 operation and replacing the beam-spitting mirror 30) the location of the beam relative the aperture surface of the Soleil-Babinet compensator should remain the same in order to ensure that the system calibration accuracy does not suffer as a result of variations in the levels of retardation that may occur across that aperture surface. To this end, the setup can be supplemented with a relatively small-aperture member (only slightly larger than the beam spot size) that is mounted to or immediately adjacent to the aperture of the Soleil-Babinet compensator 101 and in the optical path so that the same position of the beam relative to the compensator's aperture surface can be maintained irrespective of the optical setup configuration changes just mentioned.

The birefringence measurement system is then operated as explained above for measuring retardation levels of the Soleil-Babinet compensator 101 in order to determine the relationship between these measurements and the retardation levels predicted by the Soleil-Babinet compensator settings as calibrated above. In instances where there is a meaningful deviation between these levels (i.e., systematic, relative errors), a correction factor is developed and applied to the foregoing equations (6 and 7) for determining the measured birefringence of subsequently measure samples.

Once such systematic errors are corrected, it has been found that any remaining, random errors (in the present embodiment) fall within the range of ±0.2% for measured levels between 20 nm and 125 nm.

In accordance with the present invention, there is also provided a simple, alternative approach to accuracy calibration of birefringence measurement systems, as described next.

This simplified approach is carried out with the Soleil-Babinet compensator 101 locating in the optical path as shown in FIG. 1. For developing calibration/correction information for channel 1 in this approach, the Soleil-Babinet compensator 101 is oriented at exactly 0° in the manner as described above, and retardation levels are measured as described below. For channel 2, the compensator is oriented at +45° (that is, the orientation relating to the minimum 1F signal on the channel 1 detector 44).

Then, for each of channels 1 and 2, the birefringence measurement system is used to measure various levels of retardation with the compensator's micrometer positioned to select such levels of retardation within the first quadrant of the source wavelength (that is between 0.0 nm and 158.2 nm of retardance).

Similar measurements of various retardation levels are also made with the compensator's micrometer positioned to select such levels of retardation within the second quadrant of the predetermined wavelength, which is continuous with the first quadrant (that is, between 158.2 nm and 316.4 nm of retardation).

The data relating to the measured retardation levels in the first quadrant is fitted to a line using conventional linear-curve fitting techniques. The line is in terms of measured retardation (“y” ordinate) versus micrometer settings of the Soleil-Babinet compensator (“x” ordinate).

The data relating to the measured retardation levels in the second quadrant is similarly fitted to a line.

In one embodiment, and by way of example, the channel 1, first-quadrant measured data is represented by the curve-fit line as:

y=47.278x−120.45 (first quadrant data)

The channel 1, second-quadrant measure data is represented by the curve-fit line as:

y=46.442x+435.5 (second quadrant data)

The intersection of these two lines is calculated by equating the first- and second-quadrant lines, solving for “x,” and using one of the foregoing line equations to establish the data-interpolated retardation value of the Soleil-Babinet compensator when its micrometer is set to select the one-quarter wavelength retardation level.

This interpolated retardation level (in this example, 157.03 nm) is compared to the corresponding fraction of the source wavelength (that is one-quarter of 632.8 nm or 158.2 nm) and the difference (here −0.74%) is considered as the error.

As noted, the data collection, curve fitting, and error determination just described in connection with channel 1 is also carried out for channel 2.

Assuming, for example that the foregoing errors are large and different in both channels, two constants, C₁ and C₂, are used to make the birefringence measurement system report accurate results. The two constants are determined in the following equation:

$${C}_{i} = 1 \pm \{ 1 - sin [ 90 ( 1 + \frac{{E}_{i}}{100} ) ( \frac{π}{180} ) ] \}$$

where Eᵢ is the error percentage of channel i; i=1 or 2 for the two channels; the sign in “1±” corresponds to negative and positive errors, respectively.

For example, if channel 2 has a −0.91% error (E₂=−0.91),

$${C}_{2} = 1 + \{ 1 - sin [ 90 ( 1 + \frac{{E}_{i}}{100} ) ( \frac{π}{180} ) ] \} = 1.0001$$

Once C₁ and C₂ are determined, the two constants are used in the algorithm to correct the ratios of AC/DC. Thus corrected portions of equations 6 and 7 will respectively appear as:

$$\begin{matrix}\begin{matrix}\frac{{I}_{ch1} ( 1 F )}{{I}_{dc}} \cdot \frac{1 - {J}_{0} ( {Δ}_{0} )}{2 {J}_{1} ( {Δ}_{0} )} \cdot \frac{1}{\sqrt{2}} = {C}_{1} {R}_{ch1} = sin δ cos ( 2 ρ ) \\ \frac{{I}_{ch2} ( 1 F )}{{I}_{dc}} \cdot \frac{1}{2 {J}_{1} ( {Δ}_{0} )} \cdot \frac{1}{\sqrt{2}} = {C}_{2} {R}_{ch2} = sin δ sin ( 2 ρ )\end{matrix} & eqn . ( 6 c ) \\ \begin{matrix}ρ = \frac{1}{2} {tan}^{- 1} [ \frac{{C}_{2} {R}_{ch2}}{{C}_{1} {R}_{ch1}} ] or & ρ = \frac{1}{2} {ctg}^{- 1} [ \frac{{C}_{1} {R}_{ch1}}{{C}_{2} {R}_{ch2}} ] \\ δ = {sin}^{- 1} \sqrt{{( {C}_{1} {R}_{ch1} )}^{2} + {( {C}_{2} {R}_{ch2} )}^{2}} & \end{matrix} & eqn . ( 7 c )\end{matrix}$$

It is worthwhile to point out that the simplified method does not necessarily need the calibration of the Soleil-Babinet compensator as described above using crossed polarizer setup. To obtain the data for the curve-fitting, one only needs the retardation values measured on the birefringence system and the micrometer readings on the Soleil-Babinet compensator when the measurements were taken. Therefore, it eliminates the procedure of removing certain components for calibrating the Soleil-Babinet compensator, and later replacing those components.

In the foregoing, it was mentioned that the birefringence measurement system is used to measure various levels of retardation within the first and second quadrants of the source wavelength. It is noteworthy, however, that as few as two such measurements in each quadrant will suffice. Moreover, it is also contemplated that a single such measurement per quadrant will also suffice if the data for the curve-fitting is supplemented with the settings of the Soleil-Babinet compensator's micrometer as positioned for retardation levels corresponding to zero and one-half of the predetermined wavelength, since this data will provide a second point for the lines in the respective first and second quadrants.

If the components of the present system are correctly set up, the magnitude of the measured, sample-induced retardance will be independent of the sample's angular orientation. This angular independence may be lost if: (1) the polarization directions of the polarizer 22 and analyzers 42, 74 are not precisely established, and (2) the maximum peak retardance of the PEM is not precisely calibrated. What follows is a description of correction techniques for eliminating the just mentioned two sources of possible “angular dependence” errors.

As respects the precise establishment of the polarization directions of the polarizer 22 and analyzers 42, 74, the correction technique applied to the polarizer 22 involves the following steps:

1. With the PEM operating, approximately orient the polarizer 22 and the channel 1 analyzer/detector assembly 32 at 45° and −45°, respectively.

2. Rotate the polarizer 22 in fine increments while monitoring the 2F (100 kHz) lock-in amplifier signal from channel 1. When the 2F signal reaches “0” (practically, the noise level at the highest lock-in amplifier sensitivity possible), read precisely the angle on the polarizer rotator.

3. Rotate the polarizer 22 by precisely 45°, which is the correct position for the polarizer.

4. Once the position of the polarizer 22 is correctly established, turn off the PEM and rotate analyzer/detector assembly 32 while monitoring the lock-in amplifier's V_{DC} signal from channel 1. When the minimum V_{DC} signal is achieved, the position of analyzer/detector assembly 32 is set correctly.

5. Once the position of the polarizer 22 is correctly established, rotate analyzer/detector assembly 50 while monitoring the lock-in amplifier's 2F (100 kHz) signal from channel 2. When this 2F signal reaches “0” (practically, the noise level at the highest lock-in amplifier sensitivity possible), the position of analyzer/detector assembly 50 is set correctly.

As respects the calibration of the PEM, the following two techniques may be employed:

Technique 1

1. Set the channel 1 analyzer/detector assembly 32 at −45° when the polarizer 22 is at +45°.

2. Record the V_{DC} signals with a precision voltmeter while the PEM retardance is changed in the vicinity of, for example, ±10% of the selected peak retardance of the PEM.

3. Set the channel 1 analyzer/detector assembly 32 at +45°.

4. Record V_{DC} signals with a precision voltmeter while the PEM retardance is changed in the selected vicinity.

5. Plot the two V_{DC} curves against PEM retardation around the selected peak retardance. The intersection of the two curves is the retardance for J₀=0.

6. Set the PEM retardance value at the intersection value of step 5.

Technique 2

1. place a second PEM with a different frequency (for example, 55 KHz) onto the sample stage of the system as described in FIG. 1.

2. orient the second PEM (55 KHz) to exactly 45°

3. set the second PEM (55 KHz) at peak retardation of λ/4 (quarter-wave)

4. connect the 1F reference signal of the second PEM to the lock-in amplifier

5. place a sample with fairly high retardation (˜100 nm) with its fast axis set at 0°

6. vary the main PEM's driving voltage until the 1F signal at channel 2 reaches “0”

7. record the PEM's driving voltage.

The principle of technique 2 is described later in the dual PEM setups of the DUV birefringence measurement systems.

As mentioned above, the motion controllers of the sample stage 28 are controlled in a conventional manner to incrementally move the sample 26 about orthogonal (X, Y) axes, thereby to facilitate a plurality of measurements across the area of a sample. The spatial resolution of these measurements can be established as desired (e.g., 3.0 mm), provided that the sought-after resolution is not finer than the cross section of the beam that strikes the sample. In this regard, the cross sectional area or “spot size” of the laser beam may be minimized, if necessary, by the precise placement of a convex lens with an appropriate focal length, such as shown as line 96 in FIG. 1, between the light source 20 and the polarizer 22. The lens could be, for example, removably mounted to the top of the polarizer 22. The lens 96 would be in place in instances where a very small spot size of, for example, 0.1 mm (and corresponding spatial resolution) is desired for a particular sample.

In some instances it may be desirable to enlarge the spot size provided by the laser source. To this end a lens or lens system such as provided by a conventional beam expander may be introduced into the system between the laser 20 and the polarizer 22.

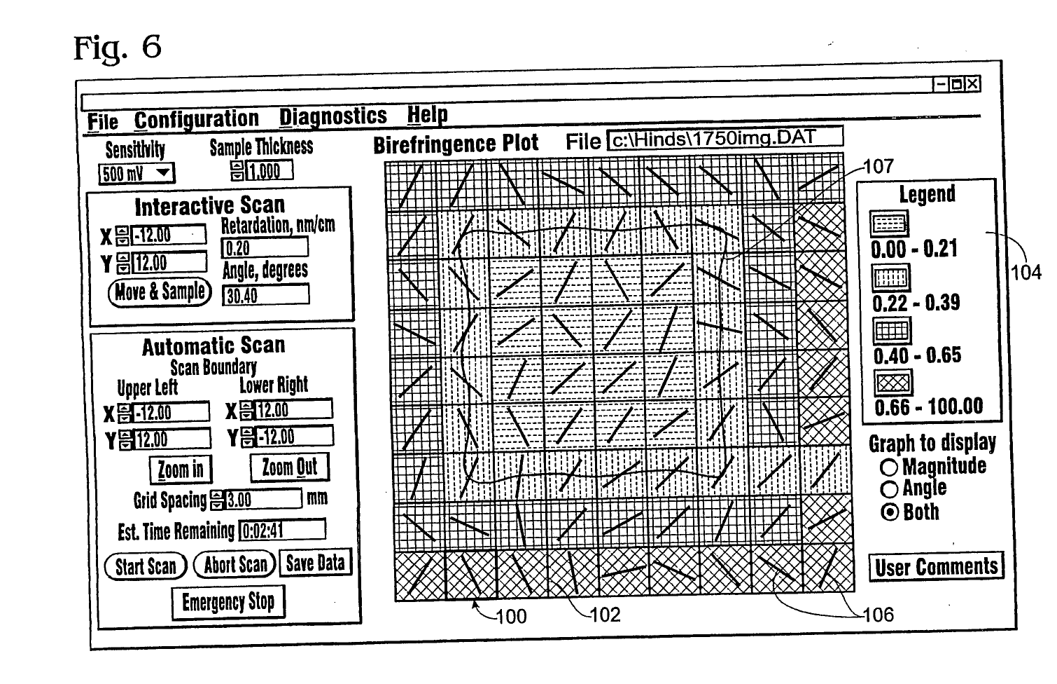

The measured retardance values can be handled in a number of ways. In a preferred embodiment the data collected from the multiple scans of a sample are stored in a data file and displayed as a plot on a computer display 92. One such plot 100 is shown in FIG. 6. Each cell 102 in a grid of cells in the plot indicates a discrete location on the sample. The magnitude of the retardance is depicted by color-coding. Here different shadings in the cells represent different colors. In FIG. 6, only a few different colors and cells are displayed for clarity. It will be appreciated, however, that a multitude of cells can be displayed. The legend 104 on the display correlates the colors (the color shading is omitted from the legend) to a selectable range of retardance values within which the particular measurement associated with a cell 102 falls. A line 106 located in each cell 102 extends across the center of each cell and presents an unambiguous visual indication of the full physical range (−90° to +90°) of the orientation of the fast axis of the sample at each sampled location. Thus, the orientation of the fast axis and the retardance magnitude measurements are simultaneously, graphically displayed for each location. With such a complete, graphical display, an inexperienced operator user is less likely to make errors in analyzing the data that are presented.

In a preferred embodiment, the just described retardance measurements are displayed for each cell as soon as that cell's information is computed. As a result of this instantaneous display approach, the operator observes the retardance value of each cell, without the need to wait until the retardance values of all of the cells in the sample have been calculated. This is advantageous for maximizing throughput in instances where, for example, an operator is charged with rejecting a sample if the birefringence value of any part of the sample exceeds an established threshold.

Also illustrated in FIG. 6 is a contour line placed there as an example of a contour line that follows a common measured range of retardation magnitude. For simplicity, only a single one of several contour lines is shown for the low-resolution plot of FIG. 6.

It will be appreciated that any of a number of variations for displaying the measured data will suffice. It will also be apparent from FIG. 6 that the means for setting parameters of how the sample is scanned (scan boundaries, grid spacing sample thickness, etc.) and the resulting data are conveniently, interactively displayed.

Another approach to graphically displaying the retardance magnitude and orientation information provided by the present system is to depict the retardance magnitude for a plurality of locations in a sample via corresponding areas on a three-dimensional contour map. The associated orientations are simultaneously shown as lines or colors in corresponding cells in a planar projection of the three dimensional map.

It will be appreciated by one of ordinary skill in the art that modifications may be made without departing from the teachings and spirit of the foregoing. For example a second lock-in amplifier may be employed (one for each channel) for increasing the speed with which data is provided to the computer.

Also, one of ordinary skill will appreciate that sequential measurement using a single detector may be employed for measuring the intensity signal in two different polarization directions and thereby defining two channels of information for subsequent processing. For example, a single detector assembly could be employed. This dispenses with the second detector assembly and the beam-splitter mirror. Such a set-up, however, would require either rotating the analyzer or switching between two polarizers of different orientations to ensure unambiguous retardance measurements and to ascertain the orientation of the fast axis. Alternatively, the sample and the analyzer may be rotated by 45°.

The preferred embodiment of the present invention uses a HeNe laser for a stable, pure, monochromatic light source. The HeNe laser produces a beam having a 632.8 nm wavelength. In some instances, retardance magnitude measurements using light sources having other frequencies are desired.

As noted in the background section above, considerations such as the nature of the light source required for retardance measurement at deep ultraviolet wavelengths (DUV) introduce the need for a somewhat different approach to birefringence measurement in the DUV environment. Such birefringence measurement systems (hereafter referred to as DUV birefringence measurement systems) can include two photoelastic modulators (PEMs) located on opposite sides of the sample. Each PEM is operable for modulating the polarity of a light beam that passes though the sample. The system also includes a polarizer associated with one PEM, an analyzer associated with the other PEM, and a detector for measuring the intensity of the light after it passes through the PEMs, the polarizer, and the analyzer.

The calibration methods of the present invention are adaptable for use with such birefringence measurement systems, as explained below.

One such DUV birefringence measurement system uses a dual PEM setup to measure low-level linear birefringence in optical elements. This system determines birefringence properties (both magnitude and angular orientation) that are the most important ones for CaF₂ and fused silica suppliers to the semiconductor industry. This system has specifically designed signal processing, a data collection scheme, and an algorithm for measuring low-level linear birefringence at very high sensitivity.

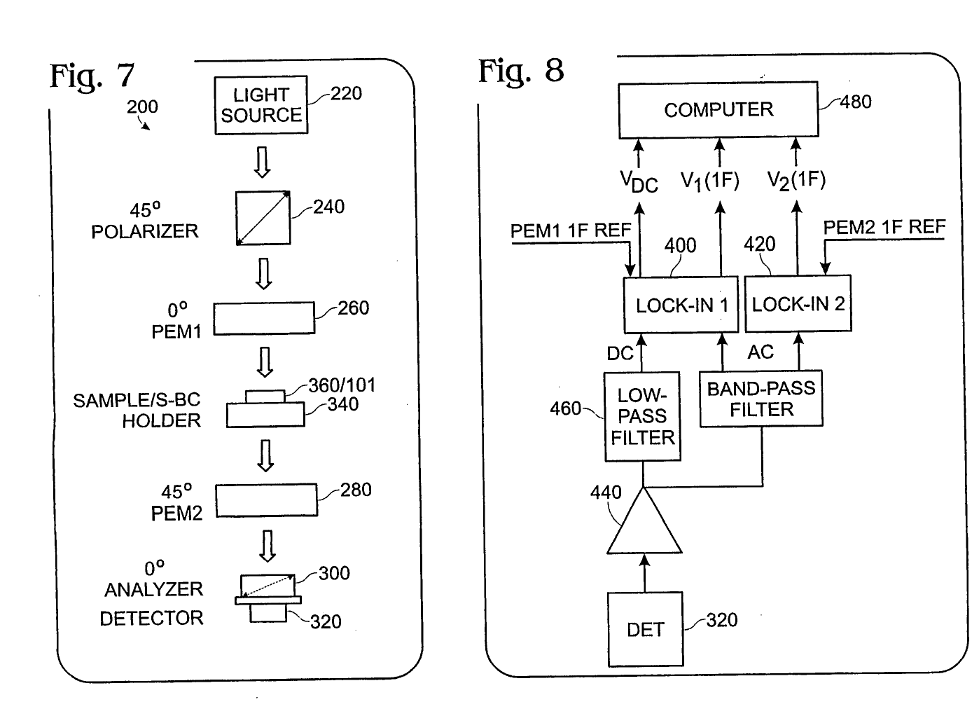

As shown in FIG. 7, the dual-PEM setup 200 of this embodiment contains three modules. The top module comprises a light source 220, a polarizer 240 oriented at 45 degrees, and a PEM 260 oriented at 0 degrees.

The bottom module includes a second PEM 280 that is set to a modulation frequency that is different from the modulation frequency of the first PEM 200. The second PEM 280 is oriented at 45 degrees. The bottom module also includes an analyzer 300 at 0 degrees and a detector 320.

The middle module is a sample holder 340 that can be mounted on a computer-controlled X-Y stage to allow the scan of an optical element or sample 360.

This system (FIGS. 7 and 8) employs as a light source 220 a polarized He—Ne laser at 632.8 nm. And, while the wavelength of this source is not DUV, the following is useful for explaining the general operation and analysis underlying the other dual-PEM embodiments explained below in connection with the DUV light sources that they employ.

With continued reference to FIG. 7, the polarizer 240 and analyzer 300 are each a Glan-Thompson-type polarizer. A Si-photodiode detector 320 is used in this embodiment. Both PEMs 260, 280 are bar-shaped, fused silica models having two transducers. The transducers are attached to the fused silica optical element with soft bonding material. To minimize birefringence induced in the optical element, only the transducers are mounted to the PEM housing. The two PEMs 260, 280 have nominal resonant frequencies of 50 and 55 KHz, respectively.

With reference to FIG. 8, the electronic signals generated at the detector 320 contain both “AC” and “DC” signals and are processed differently. The AC signals are applied to two lock-in amplifiers 400, 420. Each lock-in amplifier, referenced at a PEM's fundamental modulation frequency (1F), demodulates the 1F signal provided by the detector 320. In a preferred embodiment, the lock-in amplifier is an EG&G Model 7265.

The DC signal is recorded after the detector 320 signal passes through an analog-to-digital converter 440 and a low-pass electronic filter 460. The DC signal represents the average light intensity reaching the detector 320. As discussed next, the DC and AC signals need to be recorded at different PEM retardation settings.

The theoretical analysis underlying the measurement of the birefringence properties of the sample 360 in this embodiment is based on a Mueller matrix analysis, and is discussed next for this dual PEM-single detector embodiment of FIGS. 7 and 8.

For clarity, the Mueller matrices for three of the optical components in FIG. 7 ale shown below. The sample 360 in the optical arrangement, with a magnitude of δ and an angle of the fist axis at ρ, his the following form:

$$[ \begin{matrix}1 & 0 & 0 & 0 \\ 0 & cos ( 4 ρ ) {sin}^{2} ( \frac{δ}{2} ) + {cos}^{2} ( \frac{δ}{2} ) & sin ( 4 ρ ) {sin}^{2} ( \frac{δ}{2} ) & - sin ( 2 ρ ) sin δ \\ 0 & sin ( 4 ρ ) {sin}^{2} ( \frac{δ}{2} ) & - ( cos ( 4 ρ ) {sin}^{2} ( \frac{δ}{2} ) ) + {cos}^{2} ( \frac{δ}{2} ) & cos ( 2 ρ ) sin δ \\ 0 & sin ( 2 ρ ) sin δ & - cos ( 2 ρ ) sin δ & cos δ\end{matrix} ]$$

The Mueller matrices of the two PEMs, with the retardation axes oriented at ρ=0° and 45° are, respectively:

$$( \begin{matrix}1 & 0 & 0 & 0 \\ 0 & 1 & 0 & 0 \\ 0 & 0 & cos ( δ1 ) & sin ( δ1 ) \\ 0 & 0 & - sin ( δ1 ) & cos ( δ1 )\end{matrix} ) \qquad ( \begin{matrix}1 & 0 & 0 & 0 \\ 0 & cos ( δ2 ) & 0 & - sin ( δ2 ) \\ 0 & 0 & 1 & 0 \\ 0 & sin ( δ2 ) & 0 & cos ( δ2 )\end{matrix} )$$

where δ1 and δ2 are the time varying phase retardation of the first PEM 260 and second PEM 280 (δ1=δ1ₒ sin ω₁t and δ2=δ2ₒ sin ω₂t ; where ω₁ and ω₂ are the PEMs' modulating frequencies; δ1ₒ and δ2ₒ are the retardation amplitudes of the two PEMs).

Using the Mueller matrices of the optical components in the set-up shown in FIG. 7, the light intensity reaching the detector 320 is obtained as follows:

$$\frac{{KI}_{n}}{2} \{ 1 + cos ( δ1 ) cos ( δ2 ) sin ( 4 ρ ) {sin}^{2} ( \frac{δ}{2} ) + sin ( δ1 ) sin ( δ2 ) cos δ + cos ( δ1 ) sin ( δ2 ) cos ( 2 ρ ) sin δ + sin ( δ1 ) cos ( δ2 ) sin ( 2 ρ ) sin δ \} \qquad eqn . ( 9 )$$

where I₀ is the light intensity after the polarizer 240 and K is a constant that represents the transmission efficiency of the optical system after the polarizer.

The functions of sin δ1 and cos δ1 in equation 9 can be expanded with the Bessel functions of the first kind:

$$sin δ1 = sin ( {δ1}_{0} sin ( {ω}_{1} t ) ) = {\sum }_{2 k + 1}^{} 2 {J}_{2 k + 1} ( {δ1}_{0} ) sin ( ( 2 k + 1 ) {ω}_{1} t ) \qquad eqn . ( 10 )$$

where k is either “0 ” or a positive integer, and J₂ₖ₊₁ is the (2k+1)^{th} order of the Bessel function; and

$$cos δ1 = cos ( {δ1}_{0} sin ( {ω}_{1} t ) ) = {J}_{0} ( {δ1}_{0} ) + {\sum }_{2 k}^{} 2 {J}_{2 k} ( {δ1}_{0} ) cos ( ( 2 k ) {ω}_{1} t ) \qquad eqn . ( 11 )$$

where J₀ is the 0^{th} order of the Bessel function, and J₂ₖ is the (2k)^{th} order of the Bessel function.

Similar expansions can be made for sin δ2 and cos δ2.

Substituting the expansions of sin δ1, cos δ1, sin δ2 and cos δ2 into equation (9) and taking only up to the second order of the Bessel functions, we obtain the following terms:

$$1 + [ {J}_{n} ( {δ1}_{0} ) + 2 {J}_{2} ( {δ1}_{0} ) cos ( 2 {ω}_{1} t ) ] \cdot [ {J}_{0} ( {δ2}_{0} ) + 2 {J}_{2} ( {δ2}_{0} ) cos ( 2 {ω}_{2} t ) ] sin ( 4 ρ ) {sin}^{2} ( \frac{δ}{2} ) \qquad term ( 1 )$$

2J₁(δ1₀)sin(ω₁t)−2J₁(δ2₀)sin(ω₂t)−cos δ term (2)

$$\begin{matrix}\begin{matrix}[ {J}_{0} ( {δ1}_{0} ) + 2 {J}_{2} ( {δ1}_{0} ) cos ( 2 {ω}_{1} t ) ] \cdot [ 2 {J}_{1} ( {δ2}_{0} ) sin ( {ω}_{2} t ) ] cos ( 2 ρ ) sin δ \\ = {J}_{0} ( {δ1}_{0} ) \cdot 2 {J}_{1} ( {δ2}_{0} ) sin ( {ω}_{2} t ) cos ( 2 ρ ) sin δ + \\ 2 {J}_{2} ( {δ1}_{0} ) cos ( 2 {ω}_{1} t ) \cdot 2 {J}_{1} ( {δ2}_{0} ) sin ( {ω}_{2} t ) cos ( 2 ρ ) sin δ .\end{matrix} & term ( 3 ) \\ \begin{matrix}[ {J}_{0} ( {δ2}_{0} ) + 2 {J}_{2} ( {δ2}_{0} ) cos ( 2 {ω}_{2} t ) ] \cdot [ 2 {J}_{1} ( {δ1}_{0} ) sin ( {ω}_{1} t ) ] sin ( 2 ρ ) sin δ \\ = {J}_{0} ( {δ2}_{0} ) \cdot [ 2 {J}_{1} ( {δ1}_{0} ) sin ( {ω}_{1} t ) ] sin ( 2 ρ ) sin δ + \\ 2 {J}_{2} ( {δ2}_{0} ) cos ( 2 {ω}_{2} t ) \cdot [ 2 {J}_{1} ( {δ1}_{0} ) sin ( {ω}_{1} t ) ] sin ( 2 ρ ) sin δ\end{matrix} & term ( 4 )\end{matrix}$$

The terms (3) and (4) can be used for determining linear retardance at low levels (below π/2 or a quarter-wave). Term (2) is useful for determining linear retardance at higher levels (up to π or a half-wave). Term (1) contains DC terms that relate to the average light intensity.

The 1F AC signals on the detector 320 can be determined using the lock-in amplifiers 400, 420 referenced at the PEMs' first harmonic (1F) frequencies. The lock-in amplifier will effectively exclude the contributions from all other harmonics. The 1F signals measured by the lock-in amplifiers 400, 420 for the two PEMs 260, 280 are:

$$\begin{matrix}\sqrt{2} \cdot {V}_{1 , 1 F} = \frac{{KI}_{0}}{2} {J}_{0} ( {δ1}_{0} ) \cdot 2 {J}_{1} ( {δ2}_{0} ) cos ( 2 ρ ) sin δ \\ \sqrt{2} \cdot {V}_{2 , 1 F} = \frac{{KI}_{0}}{2} {J}_{0} ( {δ2}_{0} ) \cdot 2 {J}_{1} ( {δ1}_{01} ) sin ( 2 ρ ) sin δ\end{matrix} \qquad eqn . ( 12 )$$

where √2 results from the fact that the output of a lock-in amplifier measures the root-mean-square, not the signal amplitude. It is seen from eqn (12) that the maximum values of J₀(δ1₀)2J₁((δ2₀) and J₀(δ2₀)2J₁((δ1₀) will lead to optimal results for the output of the lock-in amplifiers. When the AC signals are collected, the retardation amplitudes of both PEMs are set to be 1.43 radians to optimize the AC signals.

The DC signal can be derived from term (1) to be:

$${V}_{D C} = \frac{{KI}_{0}}{2} \{ 1 + {J}_{0} ( {δ1}_{0} ) \cdot {J}_{0} ( {δ2}_{0} ) \cdot sin ( 4 ρ ) {sin}^{2} ( \frac{δ}{2} ) \} \qquad eqn . ( 13 )$$

where any term that varies as a function of the PEMs' modulation frequencies is omitted because they have no net contribution to the DC signal. The low-pass electronic filter 460 is used to eliminate such oscillations.

Within small angle approximation (sinX=X and sin²X=0 when X is small), V_{DC} is independent of the sample's retardation and thus represents the average light intensity reaching the detector. However, when a sample with retardation above 300 nm is measured, the V_{DC} as shown in equation (13) will generally be affected by the magnitude and angle of the retardance. Thus, the measured DC signal will not be a true representation of the average light intensity. In this case, the most straightforward method is to set both J₀(δ1₀) and J₀(δ2₀) equal to “0”. The DC signal then becomes:

$${V}_{D C} = \frac{{KI}_{0}}{2} \qquad eqn . ( 14 )$$

In this embodiment, the PEMs' retardation amplitude was selected as δ1₀=δ2₀=2.405 radians (0.3828 waves) for recording the DC signal. At such PEM settings, J₀(δ1₀)=J₀(δ2₀)=0. Therefore, the DC signal, independent of ρ or δ, truly indicates the average light intensity reaching the detector.

As seen, this method requires recording AC and DC signals at different PEM settings and thus has a slower measurement speed (about 2 seconds per data point). This method affords high accuracy measurement of linear retardance above 30 nm. When speed is critical, an alternative method can be used. If the DC signal is collected at δ1₀=δ2₀=01.43 radians, where the AC signals are recorded, the measured retardance of a sample, using the ratio of AC to DC, will depend on the sample's angular orientation. However, the DC term is well defined in equation (13). It is, therefore, possible to reduce the angular dependence of retardance by iteration of calculation for both retardation magnitude and angle.

It is also possible to use the second halves of terms 3 and 4 to determine birefringence. In this case, the birefringence signal is carried on the frequencies of 2ω₁+ω₂ (2×50 KHz+55 KHz=155 KHz) and 2ω₂+ω₁ (2×55 KHz+50 KHz=160 KHz). Therefore, an electronic “mixer” will be needed to create the reference frequencies for the lock-in amplifiers. The primary advantage of this method is that the AC and DC can be collected at the same PEM driving voltage (δ1₀=δ2₀=2.405 radians (0.3828 waves)) for faster measurement speed.

In order to eliminate the effect of light intensity variations due to light source fluctuations and the absorption, reflection and scattering from the sample and other optical components, the ratio of the 1F AC signal to the DC signal are used. The ratios of AC signals to the DC signal for both PEMs are represented in equation (15):

$$\frac{\sqrt{2} \cdot {V}_{1 , 1 F}}{{V}_{D C}} = {J}_{0} ( δ {1}_{0} ) \cdot 2 {J}_{1} ( δ {2}_{0} ) sin δ cos ( 2 ρ ) \\ \frac{\sqrt{2} \cdot {V}_{2 , 1 F}}{{V}_{D C}} = {J}_{0} ( δ {2}_{0} ) \cdot 2 {J}_{1} ( δ {1}_{0} ) sin δ sin ( 2 ρ ) \qquad eqn . ( 15 )$$

Defining R₁ and R₂ as corrected ratios for both PEMs yields:

$$\frac{\sqrt{2} \cdot {V}_{1 , 1 F}}{{J}_{0} ( δ {1}_{0} ) \cdot 2 {J}_{1} ( δ {2}_{0} ) \cdot {V}_{D C}} = {R}_{1} = sin δ cos ( 2 ρ ) \\ \frac{\sqrt{2} \cdot {V}_{2 , 1 F}}{{J}_{0} ( δ {2}_{0} ) \cdot 2 {J}_{1} ( δ {1}_{0} ) \cdot {V}_{D C}} = {R}_{2} = sin δ sin ( 2 ρ ) \qquad eqn . ( 16 )$$

Finally, the magnitude and angular orientation of the birefringence are expressed as:

$$\begin{matrix}ρ = \frac{1}{2} {tan}^{- 1} [ \frac{{R}_{2}}{{R}_{1}} ] & or & ρ = \frac{1}{2} {ctg}^{- 1} [ \frac{{R}_{1}}{{R}_{2}} ]\end{matrix} \\ δ = arc sin ( \sqrt{{( {R}_{1} )}^{2} + {( {R}_{2} )}^{2}} ) \qquad eqn . ( 17 )$$

where δ, represented in radians, is a scalar. When measured at a specific wavelength (i.e., 632.8 nm), it can be converted to retardation in nanometers: dnm=drad(632.8/(2π)).

It should be emphasized that equations (17) are specifically developed for small linear birefringence due to the use of arcsine function in determining linear birefringence. Therefore, this method described here has a theoretical upper limit of π/2 or 158.2 nm when using 632.8 nm laser as the light source.

The signals at both PEMs' modulation frequencies depend on the orientation of the fast axis of the sample (see equation (14)), and the final retardation magnitudes are independent of the fast axis angles (see equation (17)). To achieve this angular independence of retardation magnitude, it is important to accurately orient all optical components in the system (as well as those of the embodiments described below).

In this embodiment, the first PEM's optical axis is used as the reference angle (“0°”). All other optical components in the system are accurately aligned directly or indirectly with this reference angle. With the first PEM 260 being fixed, the following procedures ensure the accurate alignment of all other optical components in the system:

1. With the second PEM 280 (50 KHz) being turned off and the first PEM 260 (55 KHz) operating at quarter-wave peak retardation, the polarizer 240 and analyzer 300 are approximately oriented at +45 degrees and −45 degrees, respectively.

2. Rotate the polarizer 240 in fine increments while monitoring the 2F (110 kHz) signal from lock-in amplifier 400. When the 2F signal reaches its minimum (usually <0.05 mV with a lock-in sensitivity of 1 mV), read precisely the angle on the rotation stage of the polarizer 240.

3. Rotate the polarizer 240 by precisely 45°, which is the correct position for the polarizer.

4. Once the orientation of the polarizer 240 is correctly established, rotate the analyzer 300 in front of the detector 320 until the 2F (110 kHz) signal from lock-in amplifier 400 reaches its minimum.

5. With the first PEM 260 (55 KHz) being turned off and the second PEM 280 (50 KHz) operating at quarter-wave peak retardation, rotate the second PEM until the second 42 lock-in amplifier's 2F (100 kHz) signal reaches its minimum.

When the optical components are misaligned, retardation magnitude shows specific patterns of angular dependence.

The birefringence measurement of the present embodiment is specifically designed for accurately measuring low-level linear birefringence. In order to accurately measure such low levels of retardation, it is critical to correct for the existing residual linear birefringence of the instrument itself (instrument offset) even when high quality optical components are used.

The instrument offset is primarily due to the small residual linear birefringence in the PEMs (on the order of 0.1 nm). To correct the system offset, an average of several measurements without any sample is first obtained. The instrument offsets are corrected in the software when a sample is measured. Notice that such corrections should only be done when the ratios are calculated using equations (16), not on the final results of δ and ρ, eqn. (17). The instrument offsets should be constants (within the instrumental noise level) unless there is a change in either the alignment of optical components or laboratory conditions such as temperature. It is prudent to check the instrument offsets with some regularity.

This offset correction works within the limit of small retardance when the Mueller matrices of retardance commute. In practice, this is the only case where an offset correction is needed. Since the residual retardation in the PEMs is so small (on the order of 0.1 nm), offset correction will not be necessary when measuring retardation higher than 50 nm.

The foregoing embodiment was specifically designed for measuring low-level retardance (up to a quarter-wave of the light source's wavelength, i.e. 158 nm for a 633 nm He—Ne laser; 39 nm for the 157 nm light).

As noted earlier, the calibration methods of the present invention are adaptable for use with DUV birefringence measurement systems such as depicted in FIGS. 7 and 8. In this regard, the calibration of the setup of FIG. 7 includes the substitution of a Soleil-Babinet compensator for the sample 360 depicted in FIG. 7, and the calibration procedure proceeds as described above in connection with the simplified, curve-fitting technique for determining errors and, as necessary, applying correction factors.

It is also contemplated that calibration methods discussed above can be applied to DUV birefringence measurement systems that use a dual-wavelength light source for measuring relatively high levels of such birefringence.

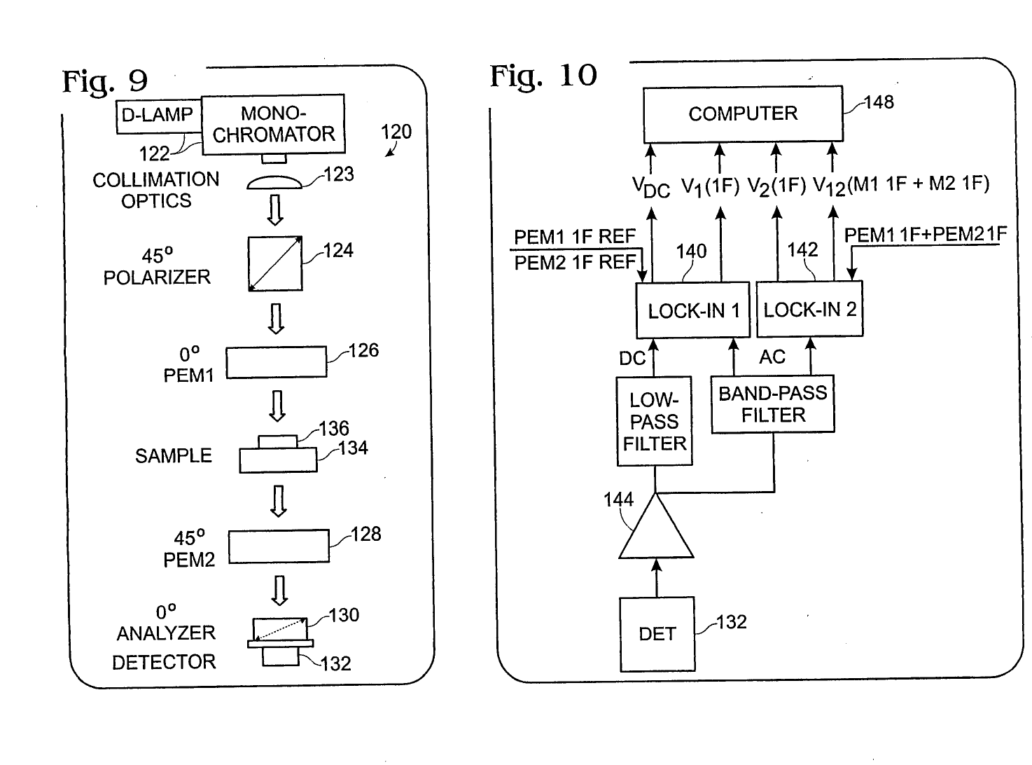

With reference to FIG. 9, the optical setup 120 for such a dual wavelength DUV birefringence measurement systems is in many respects the same as that described in connection with the embodiment of FIG. 7, including a polarizer 124 oriented at 45° and a PEM 126 at 0°. The system also includes a second PEM 128 that is set to a different modulation frequency (than the first PEM) and is oriented at 45 degrees, an analyzer 130 that is oriented at 0° and a detector 132. A sample holder 134 is mounted on a computer-controlled X-Y stage to allow the scan of a sample 360. Some differences in the structure and operation of these components, as compared with those of the earlier described embodiment, are described more fully below.

FIG. 10 shows the electronic signal processing block diagram of the present embodiment.

Unlike the prior embodiment, the embodiment of FIG. 9 incorporates a light source 122 that is capable of generating beams of different wavelengths in the DUV region. These beams are collimated 123, and separately directed through the sample 136 and processed.

In this system (FIGS. 9 and 10) the light source 122 comprises a deuterium lamp combined with a monochromator. The lamp irradiates a wide range of wavelengths. The monochromator selects the wavelength that is desired for the particular birefringence measurement application (such as 157 nm±10 nm). It is contemplated that other lamps such as mercury lamps and xenon lamps can be used for birefringence measurements in different spectral regions.

While the present invention has been described in terms of preferred embodiments, it will be appreciated by one of ordinary skill in the art that modifications may be made without departing from the teachings and spirit of the foregoing.

1. A method of calibrating a birefringence measurement system that includes an optical setup that defines a path for a light beam through crossed polarizers, and between which polarizers resides at least one polarization modulator that has an optical axis defining a reference angle, comprising the steps of:
locating between the polarizers a Soleil-Babinet compensator having an aperture surface and an optic axis and a selector mechanism for selecting a level of retardation to be induced by the Soleil-Babinet compensator;
aligning the optic axis of the Soleil-Babinet compensator with the reference angle while modulating the polarization of the light beam;
calibrating the retardation of the Soleil-Babinet compensator at a first location on the aperture surface using the crossed polarizers;
selecting a level of retardation using the selector mechanism of the calibrated Soleil-Babinet compensator;
measuring a level of retardation of the Soleil-Babinet compensator at the first location using the birefringence measurement system; and
comparing the selected retardation level and the measured retardation level to determine a difference.

2. The method of claim 1 including the step of halting the modulation of the polarization of the light beam while calibrating the retardation of the Soleil-Babinet compensator.

3. The method of claim 2 wherein the halting step includes removing the polarization modulator from the birefringence measurement system.

4. The method of claim 1 wherein there is included in the birefringence measurement system a beam-splitting member between the polarizers, the method including the step of removing the beam-splitting member while calibrating the Soleil-Babinet compensator.

5. The method of claim 1 including the step of establishing a correction factor for the birefringence measurement system based upon the difference.

6. The method of claim 1 wherein the aligning step includes rotating the Soleil-Babinet compensator while monitoring the intensity of the light beam as received on a detector of the birefringence measurement system.

7. The method of claim 6 including the step of selecting the level of retardation to be induced by the Soleil-Babinet compensator to be sufficient to achieve an angular accuracy of about 0.05 degrees.

8. The method of claim 1 wherein the birefringence measurement system includes two polarization modulators residing between the crossed polarizers, the method comprising the step of halting the modulation of the polarization of the light beam while calibrating the retardation of the Soleil-Babinet compensator.

9. The method of claim 8 wherein the halting step includes removing both polarization modulators from the birefringence measurement system.

10. The method of claim 8 wherein both polarization modulators are photoelastic modulators.

11. The method of claim 1 wherein the polarization modulator is a photoelastic modulator.

12. A method of calibrating a birefringence measurement system that includes an optical setup defining a path for a light beam through crossed polarizers, and between which polarizers resides at least one polarization modulator that has an optical axis defining a reference angle, comprising the steps of:
locating in the optical path a Soleil-Babinet compensator having an aperture surface;
calibrating the Soleil-Babinet compensator using the crossed polarizers of the birefringence measurement system to arrive at a calibrated level of retardation for a given setting on the Soleil-Babinet compensator;
measuring the retardation of the Soleil-Babinet compensator at that given setting using the polarization modulator; and
comparing the calibrated level with the measured level of retardation.

13. The method of claim 12 wherein the calibrating and measuring steps occur at substantially the same location on the aperture surface of the Soleil-Babinet compensator.

14. The method of claim 12 wherein the polarization modulator has an optical axis defining a reference angle and wherein the Soleil-Babinet compensator has an optic axis, the locating step includes rotating the Soleil-Babinet compensator to align the Soleil-Babinet compensator optic axis with the reference angle.

15. A method of calibrating a birefringence measurement system that defines a path for a light beam of a predetermined wavelength through a polarization modulator, wherein the system also includes detection means for detecting the intensity of different polarization directions of the beam for processing as distinct channels, the method comprising the steps of:
locating in the path a Soleil-Babinet compensator having a position selector for selecting a level of retardation to be induced in the beam; and for each channel:
measuring at least one level of retardation with the selected level of retardation being within a first quadrant of the predetermined wavelength;
measuring at least one level of retardation with the selected level of retardation being within a second quadrant of the predetermined wavelength that is continuous with the first quadrant;
fitting the measured retardation levels in the first and second quadrants to a line;
calculating the intersection of the lines of the first and second quadrants as an interpolated retardation level; and
comparing the interpolated retardation level with a corresponding fraction of the predetermined wavelength to determine an error.

16. The method of claim 15 wherein the measuring steps include measuring data representative of two or more levels of retardation and the fitting step includes curve-fitting the data.

17. The method of claim 15 wherein the fitting step includes using as data the positions of the selector for retardation levels corresponding to zero and one-half of the predetermined wavelength.

18. The method of claim 15 including the step of calculating for each channel a correction factor based on the errors.

19. The method of claim 15 wherein the polarization modulator has an optical axis defining a reference angle and wherein the Soleil-Babinet compensator has an optic axis, the method including the steps of:
orienting the optic axis of the Soleil-Babinet compensator at a first orientation relative to the reference angle while performing the measuring steps for one of the two channels; and
orienting the optic axis of the Soleil-Babinet compensator at a second orientation relative to the reference angle while performing the measuring steps for the other of the two channels.

20. The method of claim 15 wherein the Soleil-Babinet compensator has an aperture surface and wherein the beam impinges on the aperture surface at a first location, the method including the step of maintaining the system so that the beam impinges on the first location during the measuring steps.

21. A method of calibrating a birefringence measurement system that defines a path for light beams of predetermined wavelengths through a pair of polarization modulators that have different modulation frequencies, wherein the system also includes detection means for detecting two signals representative of the intensity of different polarization directions of the beam corresponding to the different modulation frequencies, the method comprising the steps of:
locating in the path a Soleil-Babinet compensator having a position selector for selecting a level of retardation to be induced in a beam of a predetermined wavelength; and for each signal:
measuring at least one level of retardation with the selected level of retardation being within a first quadrant of the predetermined wavelength;
measuring at least one level of retardation with the selected level of retardation being within a second quadrant of the predetermined wavelength that is continuous with the first quadrant;
fitting the measured retardation levels in the first and second quadrants to a line;
calculating the intersection of the lines of the first and second quadrants as an interpolated retardation level; and
comparing the interpolated retardation level with a corresponding fraction of the predetermined wavelength to determine an error.

22. The method of claim 21 wherein the measuring steps include measuring data representative of two or more levels of retardation and the fitting step includes curve-fitting the data.

23. The method of claim 21 wherein the fitting step includes using as data the positions of the selector for retardation levels corresponding to zero and one-half of the predetermined wavelength.

24. The method of claim 21 including the step of calculating a correction factor based on the errors.

25. The method of claim 21 wherein the Soleil-Babinet compensator has an aperture surface of and wherein beam impinges on the aperture surface at a first location, the method including the step of maintaining the system so that the beam impinges on the first location during the measuring steps.
